(19) United States
(12) Patent Application Publication
(10) Pub. No.: US 2026/0031590 A1
(43) Pub. Date: Jan. 29, 2026

(54) 1.55um ALL-FIBER LASER BASED ON TAPERING OF ULTRA-LARGE MODE AREA FIBER

(71) Applicant: Beijing University of Technology, Beijing (CN)

(72) Inventors: Pingxue LI, Beijing (CN); Yunpeng WANG, Beijing (CN); Yang LI, Beijing (CN); Wentao ZHOU, Beijing (CN)

(73) Assignee: Beijing University of Technology, Beijing (CN)

(21) Appl. No.: 19/283,329

(22) Filed: Jul. 29, 2025

(30) Foreign Application Priority Data
Jul. 29, 2024 (CN) 2024110240823

(51) Int. Cl. H01S 3/067; H01S 3/094; H01S 3/10; H01S 3/16

(52) U.S. Cl. CPC H01S 3/06745; H01S 3/06716; H01S 3/06733; H01S 3/094053; H01S 3/094076; H01S 3/10007; H01S 3/1608

(57) ABSTRACT

1.55 μm all-fiber laser based on tapering of ultra-large mode area fiber is provided, which can increase the fiber mode area, significantly enhance energy, and achieve high energy, high beam quality, narrow linewidth pulsed light, and all-fiber. The overall structure achieves an integration of the fiber laser system by fiber fusion. In the fiber laser seed source system continuous seed light output from a distributed feedback laser with an integrated isolator is modulated into pulsed light with controllable repetition rate and pulse width by an acousto-optic modulator. After amplification by a single-mode erbium-doped fiber amplifier, the signal light is amplified to an order of ten milliwatts and injected into a fiber pre-amplifier. In the fiber pre-amplifier, signal light is amplified to the order of hundreds of milliwatts by two stages of erbium-ytterbium co-doped gain fiber.

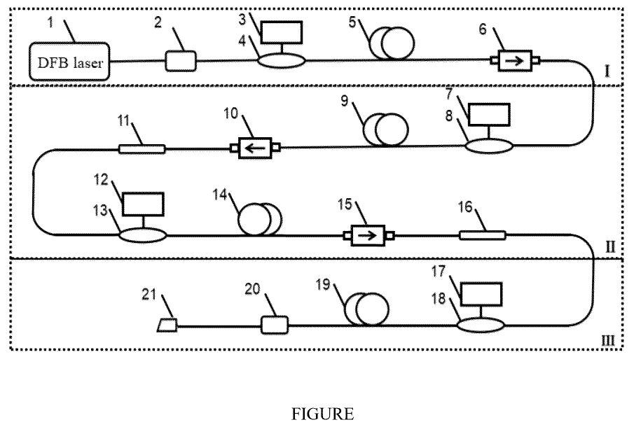

### CROSS REFERENCE TO THE RELATED APPLICATIONS

This application is based upon and claims priority to Chinese Patent Application No. 202411024082.3, filed on Jul. 29, 2024, the entire contents of which are incorporated herein by reference.

### TECHNICAL FIELD

The invention relates to a technical field of fiber lasers, in particular to a 1.55 μm all-fiber laser based on tapering of ultra-large mode area fiber.

BACKGROUND

1.55 μm narrow linewidth pulsed fiber lasers have been extensively developed and applied in recent years due to their advantages such as small size, stable operation, and good coherence. They exhibit broad application prospects and significant research value in fields such as nonlinear frequency conversion, lidar, laser ranging, and coherent combining. Especially in a field of a coherent Doppler wind lidar, to enhance detection range and accuracy, a 1.55 μm narrow linewidth pulsed light source must possess characteristics such as high repetition rate (kilohertz), large energy (millijoules), long pulse width (hundreds of nanoseconds), narrow linewidth (megahertz), and high beam quality (M²<1.5).

Stimulated Brillouin scattering (SBS) is a primary factor limiting an enhancement of peak power in narrow-linewidth pulsed fiber lasers. Specifically, a hundred-nanosecond long pulse width (significantly longer than the phonon lifetime of 10 ns) and megahertz narrow-linewidth characteristics of the lidar light source further exacerbate the SBS effect. Therefore, effective measures must be taken to suppress the SBS effect to enhance output energy. In the art, a method of cascading amplification with large-mode-area fibers is commonly employed to enhance energy. However, the fiber mode area used in current 1.55 μm narrow-linewidth pulsed fiber lasers is relatively small (core diameter ≤30 μm), limiting the energy enhancement capability. Furthermore, during the energy amplification process, large-mode-area fibers can degrade beam quality of an output laser, making it difficult to meet requirements of lidar systems.

### SUMMARY

In order to overcome the defects of the prior art, the technical problem to be solved by the invention is to provide a 1.55 μm all-fiber laser based on tapering of ultra-large mode area fiber, which can increase the fiber mode area, significantly enhance energy, and achieve high energy, high beam quality, narrow linewidth pulsed light, and all-fiber.

The technical scheme of the invention is as follows.

The 1.55 μm all-fiber laser based on tapering of ultra-large mode area fiber, comprises a fiber laser seed source system (I), a fiber pre-amplifier (II), and a fiber main amplifier (III). The overall structure achieves an integration of the fiber laser system by fiber fusion.

In the fiber laser seed source system, continuous seed light output from a distributed feedback laser with an integrated isolator is modulated into pulsed light with controllable repetition rate and pulse width by an acousto-optic modulator. After amplification by a single-mode erbium-doped fiber amplifier, the signal light is amplified to an order of ten milliwatts and injected into a fiber pre-amplifier.

In the fiber pre-amplifier, signal light is amplified to the order of hundreds of milliwatts by two stages of erbium-ytterbium co-doped gain fiber.

In the main fiber amplifier, a large-mode-area erbium-ytterbium co-doped fiber with a core diameter of 50 μm˜70 μm and a cladding diameter of 500 μm˜700 μm is used to suppress the SBS effect, boost the signal light power to the order of watts, and achieve an output pulse energy in the order of milli-joule.

The beneficial technical effects of the present invention are as follows.
1. The main amplifier of the present invention utilizes a short-length, highly doped, ultra-large mode area erbium-ytterbium co-doped fiber as a gain fiber, effectively increasing a threshold of stimulated Brillouin scattering in narrow-linewidth pulse fiber lasers, and achieving high-energy narrow-linewidth pulse laser output in the order of milli-joules.
2. In the present invention both ends of an ultra-large mode area gain fiber are tapered to effectively filter out a high-order mode transmitted in the ultra-large mode area fiber, thereby significantly improving beam quality of a high-energy laser. Moreover, the tapered gain fiber matches a commercial passive fiber, and after fusion, forms an all-fiber system, which has the advantages of simple structure and easy packaging.
3. In the present invention a pulse shaping technology is employed to compensate for a gain saturation phenomenon that occurs during a high-gain amplification process, effectively suppressing the SBS effect caused by excessively high peak power at a pulse rising edge. Under the same peak power conditions, it enhances the pulse energy.

### BRIEF DESCRIPTION OF THE DRAWINGS

The figure is a schematic diagram of an optical path of the system according to the present invention.

In the drawing, 1—a distributed feedback (DFB) laser with an integrated isolator, 2—an acousto-optic modulator, 3—a first semiconductor laser, 4—a wavelength division multiplexer, 5—a first gain fiber, 6—a first fiber isolator, 7—a second semiconductor laser, 8—a first fiber combiner, 9—a second gain fiber, 10—a second fiber isolator, 11—a first fiber bandpass filter, 12—a third semiconductor laser, 13—a second fiber combiner, 14—a third gain fiber, 15—a third fiber isolator, 16—a second fiber bandpass filter, 17—a fourth semiconductor laser, 18—a third fiber combiner, 19—a fourth gain fiber, 20—a cladding light filter, 21—an output end cap.

### DETAILED DESCRIPTION OF THE EMBODIMENTS

In order to enable those in the art to better understand the scheme of the invention, the technical scheme in embodiments of the invention will be clearly and completely described below in combination with the attached drawings in the embodiments of the invention. Obviously, the described embodiments are only part of the embodiments of the invention, not all of them. Based on the embodiments of the invention, all other embodiments obtained by those skilled in the art without creative work should be within the scope of the invention.

It should be noted that the term “including” and any variation in the specification and claims of the invention and the above drawings are not intended to cover exclusive inclusion. For example, a process, method, means, product or device that contains a series of steps or units need not be limited to those steps or units clearly listed, but may include other steps or units that are not clearly listed or inherent to the process, method, product or device.

As shown in the figure, the 1.55 μm all-fiber laser based on tapering of ultra-large mode area fiber, comprises a fiber laser seed source system I, a fiber pre-amplifier II, and a fiber main amplifier III. The overall structure achieves an integration of the fiber laser system by fiber fusion.

In the fiber laser seed source system, continuous seed light output from a distributed feedback laser with an integrated isolator is modulated into pulsed light with controllable repetition rate and pulse width by an acousto-optic modulator. After amplification by a single-mode erbium-doped fiber amplifier, the signal light is amplified to an order of ten milliwatts and injected into a fiber pre-amplifier.

In the fiber pre-amplifier, signal light is amplified to the order of hundreds of milliwatts by two stages of erbium-ytterbium co-doped gain fiber.

In the main fiber amplifier, a large-mode-area erbium-ytterbium co-doped fiber with a core diameter of 50 μm˜70 μm and a cladding diameter of 500 μm˜700 μm is used to suppress the SBS effect, boost the signal light power to the order of watts, and achieve an output pulse energy in the order of milli-joule.

The beneficial technical effects of the present invention are as follows.
1. The main amplifier of the present invention utilizes a short-length, highly doped, ultra-large mode area erbium-ytterbium co-doped fiber as a gain fiber, effectively increasing a threshold of stimulated Brillouin scattering in narrow-linewidth pulse fiber lasers, and achieving high-energy narrow-linewidth pulse laser output in the order of milli-joules.
2. In the present invention both ends of an ultra-large mode area gain fiber are tapered to effectively filter out a high-order mode transmitted in the ultra-large mode area fiber, thereby significantly improving beam quality of a high-energy laser. Moreover, the tapered gain fiber matches a commercial passive fiber, and after fusion, forms an all-fiber system, which has the advantages of simple structure and easy packaging.
3. In the present invention a pulse shaping technology is employed to compensate for a gain saturation phenomenon that occurs during a high-gain amplification process, effectively suppressing the SBS effect caused by excessively high peak power at a pulse rising edge. Under the same peak power conditions, it enhances the pulse energy.

Preferably, the fiber laser seed source system comprises: a distributed feedback laser 1, an acousto-optic modulator 2, a fiber wavelength division multiplexer 4, a first semiconductor laser 3, a first gain fiber 5, and a first fiber isolator 6. The distributed feedback laser outputs continuous laser light, which is connected to the acousto-optic modulator via a first fiber jumper wire. A second jumper wire connected to the acousto-optic modulator is connected to a signal fiber end of the fiber wavelength division multiplexer. An output end of a first semiconductor laser is connected to a pump fiber end of the fiber wavelength division multiplexer. The output end of the fiber wavelength division multiplexer is connected to an input end of the first gain fiber. An output end of the first gain fiber is connected to an input end of the first fiber isolator.

Preferably, the optical fiber pre-amplifier consists of a cascade of two multimode fiber amplifiers, including: a first optical fiber combiner 8, a second semiconductor laser 7, a second gain fiber 9, a second optical fiber isolator 10, a first optical fiber bandpass filter 11, a second optical fiber combiner 13, a third semiconductor laser 12, a third gain fiber 14, a third optical fiber isolator 15, and a second optical fiber bandpass filter 16.

Preferably, the main fiber amplifier consists of a first-stage large-core erbium-ytterbium co-doped gain fiber and cooperating passive fiber components, including a third fiber combiner 18, a fourth semiconductor laser 17, a fourth gain fiber 19, a cladding light filter 20, and an output end cap 21.

Preferably, the distributed feedback laser is a distributed feedback laser with an integrated isolator whose output wavelength is 1.55 μm. It emits seed light power of 100 mW and a linewidth on the order of kHz.

Preferably, the first gain fiber is a single-mode erbium-doped fiber with a fiber core diameter of 8 μm˜9 μm, an inner cladding diameter of 125 μm˜130 μm, and an absorption coefficient for pump light at 976 nm of 20 dB/m˜40 dB/m.

Preferably, the second and third gain fibers are double-clad erbium-ytterbium co-doped fibers, with a fiber core diameter of 10 μm˜30 μm, an inner cladding diameter of 130 μm˜300 μm, and an absorption coefficient for pump light at 976 nm of 3 dB/m˜5 dB/m.

The fourth gain fiber is an erbium-ytterbium co-doped large-core high-doped fiber, with a fiber core diameter of 50 μm˜70 μm, an inner cladding diameter of 500 μm˜700 μm, and an absorption coefficient for pump light at 976 nm of 9 dB/m˜10 dB/m.

Preferably, the chamfer angle of the main amplifier end cap is selected to be greater than 15°, and the output end cap has a transmittance of more than 99% for laser wavelengths.

Preferably, the fiber tapering method involves tapering both ends of the ultra-large mode area fiber and fusing it with a matching passive fiber to form an all-fiber system.

Preferably, the desired waveform is edited and added to an acoustic optical modulator (AOM), and a continuous laser is modulated into a pulse laser with a delayed rising edge and a steep falling edge to suppress the SBS phenomenon.

The invention will be further described in detail below in combination with the accompanying drawings.

As shown in the figure, the 1.55 μm all-fiber laser based on tapering of ultra-large mode area fiber according to the present invention with high-energy, high-beam-quality, narrow-linewidth pulse, comprises: the fiber laser seed source system I, the fiber pre-amplifier II, and the fiber main amplifier III. The DFB laser which can output continuous laser, has an output power up to 100 mW. After being modulated by the acousto-optic modulator using pulse shaping technology, it is modulated into microwatt-level pulsed light with controllable pulse width and repetition rate. The power is amplified to the mW level after one pre-amplification stage. The fiber pre-amplifier II is composed of two cascaded multimode fiber amplifiers. The fiber main amplifier III is composed of a large-core gain fiber and cooperating passive fiber components. The fiber laser seed source system I, fiber pre-amplifier II, and fiber main amplifier III are connected in sequence.

The fiber laser seed source system I comprises the distributed feedback laser with the isolator 1, the acousto-optic modulator 2, the first semiconductor laser 3, the wavelength division multiplexer 4, the first gain fiber 5, and the first fiber isolator 6. The signal output fiber of the distributed feedback laser with an isolator 1 is connected to the first jumper wire of the acousto-optic modulator 2, the second jumper wire of the acousto-optic modulator 2 is connected to the signal fiber end of the wavelength division multiplexer 4, the pump fiber end of the wavelength division multiplexer 4 is connected to the output fiber of the first semiconductor laser 3, the output end of the wavelength division multiplexer is connected to the input end of the first gain fiber 5, and the output end of the first gain fiber 5 is connected to the input end of the first fiber isolator 6.

The fiber pre-amplifier II consists of a cascade of two multimode fiber amplifiers, including a first fiber combiner 8, a second semiconductor laser 7, a second gain fiber 9, a second fiber isolator 10, a first fiber bandpass filter 11, a second fiber combiner 13, a third semiconductor laser 12, a third gain fiber 14, a third fiber isolator 15, and a second fiber bandpass filter 16.

In the two-stage multimode amplifier, the gain fiber has a fiber core diameter of 10 μm˜30 μm, an inner cladding diameter of 130 μm˜300 μm, and an absorption coefficient for pump light at 976 nm of 3 dB/m˜5 dB/m.

The output end of the first optical fiber isolator 6 is connected to the signal fiber end of the first optical fiber combiner 8, the pump fiber end of the first optical fiber combiner 8 is connected to the output end of the second semiconductor laser 7, the output end of the first optical fiber combiner 8 is connected to the input end of the second gain fiber 9, the output end of the second gain fiber 9 is connected to the input end of the second optical fiber isolator 10, the output end of the second optical fiber isolator 10 is connected to the input end of the first optical fiber bandpass filter 11, the output end of the first optical fiber bandpass filter 11 is connected to the signal fiber end of the second optical fiber combiner 13, the pump fiber end of the second optical fiber combiner 13 is connected to the output end of the third semiconductor laser 12, the output end of the second optical fiber combiner 13 is connected to the input end of the third gain fiber 14, the output end of the third gain fiber 14 is connected to the input end of the third optical fiber isolator 15, and the output end of the third optical fiber isolator 15 is connected to the input end of the second optical fiber bandpass filter 16.

The main fiber amplifier III consists of a first-stage large-core erbium-ytterbium co-doped gain fiber and cooperating passive fiber components, including a third fiber combiner 18, a fourth semiconductor laser 17, a fourth gain fiber 19, a cladding light filter 20, and an output end cap 21.

The output end of the second optical fiber bandpass filter 16 is connected to the signal fiber end of the third optical fiber combiner 18, the pump fiber end of the third optical fiber combiner 18 is connected to the output end of the fourth semiconductor laser 17, the output end of the third optical fiber combiner 18 is connected to the input end of the fourth gain fiber 19, the output end of the fourth gain fiber 19 is connected to the input end of the cladding light filter 20, and the output end of the cladding light filter 20 is fused with the output end cap 21.

The chamfer angle of the main amplifier end cap is selected to be greater than 15°,and the output end cap has a transmittance of more than 99% for laser wavelengths.

The main amplifier gain fiber is an erbium-ytterbium co-doped large-core high-doped fiber, with a fiber core diameter of 50 μm˜70 μm, an inner cladding diameter of 500 μm˜700 μm, and an absorption coefficient for pump light at 976 nm of 9 dB/m˜10 dB/m.

The cladding light filter is prepared by coating a high refractive index polymer on the cladding of a passive optical fiber. The passive optical fiber is matched with a large-core erbium-ytterbium co-doped fiber after being tapered, with a fiber core diameter of 50 μm˜70 μm and an inner cladding diameter of 500 μm˜700 μm.

Each module of the laser in the invention adopts a fully fiber fusion method, featuring compact structure, stable performance, and ease of packaging. It can achieve a high-energy narrow-linewidth pulse laser output in the order of milli-joules. The main amplifier in the invention utilizes a short-length, highly doped, ultra-large mode area erbium-ytterbium co-doped fiber as the gain fiber, effectively increasing the threshold of stimulated Brillouin scattering in narrow-linewidth pulse fiber lasers and achieving high-energy narrow-linewidth pulse laser output in the order of milli-joules. In the present invention both ends of an ultra-large mode area gain fiber are tapered to effectively filter out a high-order mode transmitted in the ultra-large mode area fiber, thereby significantly improving beam quality of a high-energy laser. Moreover, the tapered gain fiber matches a commercial passive fiber, and after fusion, forms an all-fiber system, which has the advantages of simple structure and easy packaging. In the present invention a pulse shaping technology is employed to compensate for a gain saturation phenomenon that occurs during a high-gain amplification process, effectively suppressing the SBS effect caused by excessively high peak power at a pulse rising edge. Under the same peak power conditions, it enhances the pulse energy.

The above contents are only the preferable embodiments of the present invention, and do not limit the present invention in any manner. Any improvements, amendments and alternative changes made to the above embodiments according to the technical spirit of the present invention shall fall within the claimed scope of the present invention.

What is claimed is:

1. A 1.55 μm all-fiber laser based on tapering of ultra-large mode area fiber, comprising a fiber laser seed source system, a fiber pre-amplifier, and a fiber main amplifier, wherein an overall structure achieves an integration of a fiber laser system by fiber fusion,
in the fiber laser seed source system, continuous seed light output from a distributed feedback laser with an integrated isolator is modulated into pulsed light with controllable repetition rate and pulse width by an acousto-optic modulator; after amplification by a single-mode erbium-doped fiber amplifier, a signal light is amplified to an order of ten milliwatts and injected into a fiber pre-amplifier;
in the fiber pre-amplifier, signal light is amplified to an order of hundreds of milliwatts by two stages of erbium-ytterbium co-doped gain fiber; and
in the fiber main amplifier, a large-mode-area erbium-ytterbium co-doped fiber with a core diameter of 50 μm˜70 μm and a cladding diameter of 500 μm˜700 μm is configured to suppress a Stimulated Brillouin scattering (SBS) effect, boost a signal light power to an order of watts, and achieve an output pulse energy in an order of milli-joule.

2. The 1.55 μm all-fiber laser according to claim 1, wherein the fiber laser seed source system comprises: a distributed feedback laser, an acousto-optic modulator, a fiber wavelength division multiplexer, a first semiconductor laser, a first gain fiber, and a first fiber isolator, wherein
the distributed feedback laser outputs continuous laser light, wherein the distributed feedback laser is connected to the acousto-optic modulator via a first fiber jumper wire, a second jumper wire connected to the acousto-optic modulator is connected to a signal fiber end of the fiber wavelength division multiplexer, an output end of a first semiconductor laser is connected to a pump fiber end of the fiber wavelength division multiplexer, an output end of the fiber wavelength division multiplexer is connected to an input end of the first gain fiber, and an output end of the first gain fiber is connected to an input end of the first fiber isolator.

3. The 1.55 μm all-fiber laser according to claim 2, wherein the fiber pre-amplifier consists of a cascade of two multimode fiber amplifiers, comprising: a first optical fiber combiner, a second semiconductor laser, a second gain fiber, a second optical fiber isolator, a first optical fiber bandpass filter, a second optical fiber combiner, a third semiconductor laser, a third gain fiber, a third optical fiber isolator, and a second optical fiber bandpass filter.

4. The 1.55 μm all-fiber laser according to claim 3, wherein the fiber main amplifier consists of a first-stage large-core erbium-ytterbium co-doped gain fiber and cooperating passive fiber components, comprising a third fiber combiner, a fourth semiconductor laser, a fourth gain fiber, a cladding light filter, and an output end cap.

5. The 1.55 μm all-fiber laser according to claim 4, wherein the distributed feedback laser is a distributed feedback laser with an integrated isolator, wherein an output wavelength of the distributed feedback laser is 1.55 μm, and the distributed feedback laser emits seed light power of 100 mW and a linewidth on an order of kHz.

6. The 1.55 μm all-fiber laser according to claim 5, wherein the first gain fiber is a single-mode erbium-doped fiber with a fiber core diameter of 8 μm˜9 μm, an inner cladding diameter of 125 μm˜130 μm, and an absorption coefficient for pump light at 976 nm of 20 dB/m˜40 dB/m.

7. The 1.55 μm all-fiber laser according to claim 6, wherein the second and third gain fibers are double-clad erbium-ytterbium co-doped fibers, with a fiber core diameter of 10 μm˜30 μm, an inner cladding diameter of 130 μm˜300 μm, and an absorption coefficient for pump light at 976 nm of 3 dB/m˜5 dB/m; and the fourth gain fiber is an erbium-ytterbium co-doped large-core high-doped fiber, with a fiber core diameter of 50 μm˜70 μm, an inner cladding diameter of 500 μm˜700 μm, and an absorption coefficient for pump light at 976 nm of 9 dB/m˜10 dB/m.

8. The 1.55 μm all-fiber laser according to claim 4, wherein a chamfer angle of a main amplifier end cap is selected to be greater than 15°, and the output end cap has a transmittance of more than 99% for laser wavelengths.

9. The 1.55 μm all-fiber laser according to claim 1, wherein a fiber tapering method involves tapering both ends of the ultra-large mode area fiber and fusing the ultra-large mode area fiber with a matching passive fiber to form an all-fiber system.

10. The 1.55 μm all-fiber laser according to claim 1, wherein a desired waveform is edited and added to an acoustic optical modulator (AOM), and a continuous laser is modulated into a pulse laser with a delayed rising edge and a steep falling edge to suppress an SBS phenomenon.
